(19) United States
(12) Patent Application Publication
(10) Pub. No.: US 2018/0078873 A1
(43) Pub. Date: Mar. 22, 2018

(54) Desalination Plant

(71) Applicant: David Van Curen, Lancaster, OH (US)

(72) Inventor: David Van Curen, Lancaster, OH (US)

(73) Assignee: David Van Curen

(21) Appl. No.: 15/268,565

(22) Filed: Sep. 17, 2016

(51) Int. Cl. B01D 3/02; C02F 1/04

(52) U.S. Cl. CPC B01D 3/02; C02F 2103/08; C02F 1/04

(57) ABSTRACT

The invention relates to a desalination plant for producing potable water. The desalination plant includes a housing unit that comprises a vapor producing chamber positioned within the housing unit, an inlet water pipe for delivering salt water, a fuel line, and a vapor producing wheel that includes an internal heating source, and a condenser unit positioned at the top of the housing unit for converting vapor to potable water. The inlet salt water pipe delivers salt water from a source into the housing unit and over the surface of the vapor producing chamber. The vapor producing chamber is rotatable around a central axis and when heated by the heat source produces vapor that is fed into the condenser. The condenser converts the vapor to potable water.

### TECHNICAL FIELD

The present invention relates generally to desalination and water production. In particular, it relates to a process for converting a impure or saline water stream, such as seawater, into pure water, where this desalination process can be via thermal process.

### BACKGROUND

It has long been known that potable water can be manufactured from impure or saline water by many processes such as distillation, e.g. freezing or heating etc. In many of these processes a large amount of energy must be spent and complicated equipment utilized. As such, producing potable drinking water may be far too expensive and complicated in operation and maintenance for many. As water sources become more and more scarce due to over consumption or environmental conditions, there will be a need to provide means to convert impure or saline water to potable drinking water in a way that is feasible for those that do not have the resources or means to do so with traditional approaches. Therefore, it is desired to develop a method and means to manufacture a desalination plant that can be easy to manufacture and easy to use.

### SUMMARY

The present invention is directed to a desalination plant which provides an inexpensive and efficient technique for producing potable water from seawater.

According to this invention, a desalination plant for producing potable water in a cost-effective and easy manner is presented. The desalination plant includes a housing unit for housing the desalination components. The housing unit includes a chamber that is shaped in the form of a cylinder for producing vapor. The chamber includes internally a drive shaft with a hollow interior. The drive shaft includes ends fixed to the housing unit and further includes a center shaft mounted between the two ends with the center shaft rotatable around a central axis. The chamber is coupled with the center shaft and is also rotatable about the central axis. The center shaft includes at least one heating nozzle for heating the surface of the chamber. The housing unit further includes a power source for driving the center shaft. The housing unit further includes a fuel line that delivers fuel through the drive shaft to the at least one heating nozzle. The housing unit further includes an inlet water pipe fixed at one end to a impure water source and fixed to the housing unit on the other end. The inlet water pipe provides seawater into the housing unit and over an outer surface of the chamber and when the chamber is heated results in the production of vapor. The housing unit further includes a condenser unit fixed to the housing unit that receives the vapor produced from the vapor producing chamber and an outlet pipe for providing condensate from the vapor.

According to another embodiment of this invention, a desalination plant for producing potable water in a cost-effective and easy manner is presented. The desalination plant includes a housing unit for housing the desalination components. The housing unit includes a vapor producing chamber that is shaped in the form of a cylinder. The chamber includes internally a drive shaft. The drive shaft includes ends fixed to the housing unit and further includes a center shaft mounted between the two ends with the center shaft rotatable around a center axis. The chamber is coupled with the center shaft and is also rotatable about the central axis. The housing unit also includes a fuel line shaft with a hollow interior for delivering fuel from a fuel source. The fuel line shaft is fixed to the housing unit and traverses through a central area of the vapor producing chamber. The fuel line shaft includes at least one heating nozzle coupled to the shaft for heating the surface of the rotatable chamber. The housing unit further includes an inlet water pipe fixed at one end to a impure water source and fixed to the housing unit on the other end. The inlet water pipe provides saline water into the chamber and over an outer surface of the chamber and when the chamber is heated results in the production of vapor. The housing unit further includes a condenser unit fixed to the housing unit that receives the vapor produced from the vapor producing chamber and an outlet pipe for providing condensate from the vapor.

### BRIEF DESCRIPTION OF THE DRAWINGS

FIG. 1 is a side view of a desalination plant that includes a vapor producing cylinder for producing potable water from impure or saline water according to an embodiment of the invention.

FIG. 2A is a perspective view of the vapor producing cylinder of the desalination plant according to an embodiment of the invention.

FIG. 2B is a power generation source for driving the vapor producing cylinder of FIGS. 1 and 2A according to an embodiment of the invention.

### DETAILED DESCRIPTION OF THE PRESENTLY PREFERRED EMBODIMENTS

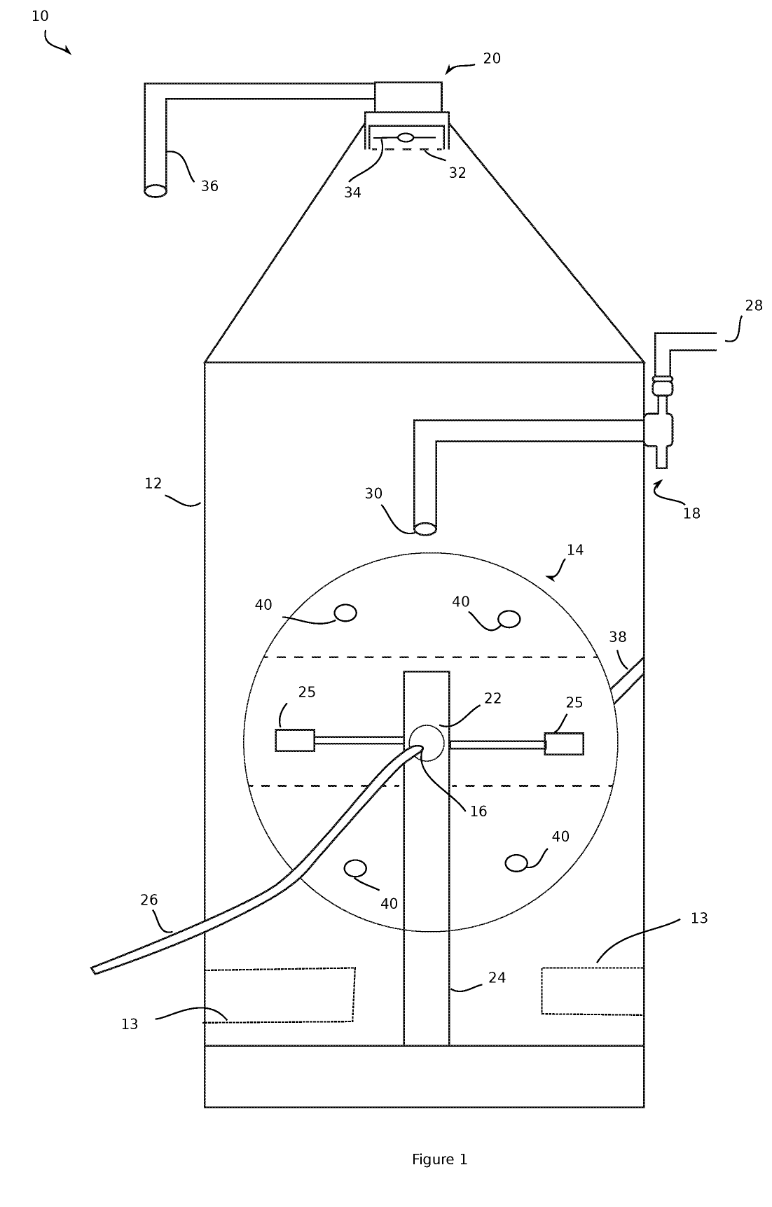

Referring to FIG. 1, illustrated is a desalination plant for removing impurities from water, such as seawater, and is denoted generally as 10. The desalination plant 10 effectively operates like a liquor still with necessary exceptions that allow the plant 10 to produce drinkable water from saline water in a simple and cost-effective manner. The plant 10 includes a housing unit 12 with air ventilation shafts 13, a vapor producing chamber 14, a power source, which is not illustrated in FIG. 1, for driving the chamber 14, a fuel line feeder 16, an inlet water pipe 18, and a condenser unit 20.

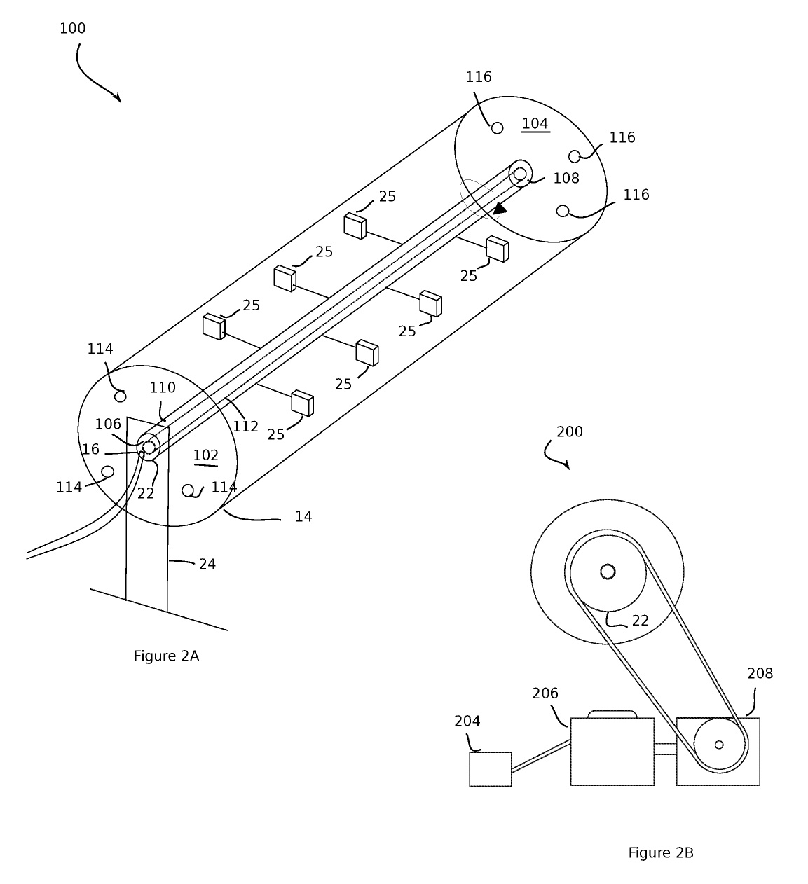

The vapor producing chamber 14 may be shaped in the form of a cylinder or wheel that rotates about a central axis. The vapor producing chamber further includes an internal drive shaft 22 with a hollow interior. The drive shaft 22 may include ends fixed to the housing unit 12 or a support beam 24 and may further include a center shaft with the center shaft, as illustrated in FIG. 2A, rotatable around a central axis, e.g. using a roller bearing system. The center shaft may include at least one heating nozzle 25 attached thereto for heating the surface of the chamber. The chamber is coupled with the center shaft and also rotates about the central axis. In an alternative embodiment, as will be discussed in reference to FIG. 2A, the center shaft may be dual part allowing the chamber 14 to rotate but the heating nozzles 25 to remain stationary and not rotate about the center axis.

The fuel line feeder 16 can be coupled with a fuel line 26 that extends to a fuel source, not illustrated, so that fuel can be delivered threw the hollowed drive shaft 22. Fuel fed through the drive shaft 22 provides fuel to the heating nozzles 25 positioned along the outer surface center shaft and when ignited heats the surface of the chamber 14 resulting in vapor production when water is applied to the surface.

The inlet water pipe includes an inlet water source 28 for delivering impure water and an outlet source for delivering the impure water source 30 over the outer surface of the chamber 14. A power source is also provided, as illustrated in FIG. 2B, that drives the rotation of the chamber 14. When the center shaft is provided with fuel and the heating nozzles 25 are ignited, the outer surface is heated to a sufficient level to boil the saline water. Vapor produced from this process can then be collected and a condensate from the vapor produced. A byproduct of the desalination of the impure water can be salt which in can be removed from the surface of the chamber by blade 38 that comes in approximate or near contact with the chamber 14.

The condenser 20 includes a vent 32 leading into a ventilation duct wherein a suction fan 34 pulls vapor produced off of the heated cylinder 14 into an ambient environment that causes the vapor to produce water condensate through a condenser outlet 36, or what some may call a worm in the manufacture of liquor. In addition, the chamber can include ventilation vents 40 positioned on the ends of the chamber to allow air within the chamber.

In the above described invention, the fuel source provided may be natural gas, for which there is currently an abundant supply throughout the world. The heating nozzles may be nozzles of a type provided by manufactures and providers of welding equipment for cutting and welding metals.

Referring now to FIGS. 2A and 2B, illustrated in FIG. 2A is a perspective view of the vapor producing chamber 14 denoted generally as 100 and illustrated in FIG. 2B is an example of a drive source for driving chamber 20 denoted generally as 200. In FIG. 2A, chamber 14 includes a first end 102 and a second end 104 with the first end 102 mounted to the support member 24 or directly to the housing unit 12 and the second end mounted to the drive source 200 of FIG. 2B. The chamber 14 further includes drive shaft 22 with heating nozzles 25 positioned along the drive shaft 22. In FIG. 2B, an example power source is presented to drive the chamber 14 that includes an electric speed controller 204 for adjusting the amount of force directed to driving the chamber 14, a motor 206 for delivering the required power, and a gear box 208 for rotating the drive shaft 22 of chamber 14.

In FIG. 2A, the drive shaft 22 of chamber 14 further includes mountable ends 106,108 fixed to the housing unit 12 and/or support member. The ends 106,108 have coupled there between a center shaft 110 and the center shaft 100 is rotatable around a central axis; the chamber 14 also is coupled with the central shaft 110 and rotatable about the central axis with the central shaft 110. The center shaft 110 includes at least one heating nozzle 25 for heating the surface of the chamber 14. In this embodiment, the chamber 14 and the center shaft 110 each rotate about the central axis. The rotatable shafts may be rotatable using roller bearing systems, e.g.

Alternatively, the vapor producing chamber 14 maybe attached to an axle 112 with ends attached to the housing unit and or support member and a central axle positioned there between and centrally positioned within the chamber so that is rotatable about a central axis. In addition, the chamber 14 includes the center shaft 110 with a hollow interior for delivering fuel from the fuel source through fuel line feed 16. The center shaft 110, in this embodiment, is fixed to the housing unit 12 and traverses through a central area of the vapor producing chamber 14. The central shaft 110 includes at least one heating nozzle 25 coupled to the shaft for heating the surface of the chamber. In other words, in the alternative embodiment the chamber 14 rotates about its central axis but the central shaft 110 remains stationary, thus requiring less power to heat the saline water. The rotatable shafts may be rotatable using roller bearing systems, e.g. In each embodiment, In addition, the chamber can include ventilation vents 40 positioned on the ends of the chamber to allow air within the chamber.

Thus, While there have been shown and described and pointed out fundamental novel features of the invention as applied to a preferred embodiment thereof, it Will be under stood that various omissions and substitutions and changes in the form and details of the devices illustrated, and in their operation, may be made by those skilled in the art Without departing from the spirit of the invention. For example, it is expressly intended that all combinations of those elements and/or method steps Which perform substantially the same function in substantially the same Way to achieve the same results are Within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A desalination plant for producing potable water comprising:
a housing unit;
a vapor producing chamber shaped in the form of a cylinder that includes internally a drive shaft with a hollow interior, the drive shaft includes ends fixed to the housing unit and further includes a center shaft with the center shaft rotatable around a central axis, the chamber being coupled with the center shaft and also rotatable about the central axis, the center shaft including at least one heating nozzle for heating the surface of the chamber;
a power source for driving the center shaft;
a fuel line extending from a fuel source through the drive shaft for feeding fuel to the at least one heating nozzle;
an inlet water pipe fixed at one end to a seawater source and fixed to the housing unit on the other end, the inlet water pipe providing seawater over an outer surface of the chamber; and
an condenser unit fixed to the housing unit that receives vapor produced from the vapor producing chamber and an outlet pipe for providing condensate from the vapor.

2. The desalination plant as recited in claim 1 wherein the fuel source is natural gas.

3. The desalination plant of claim 1 wherein the condenser unit includes a suction fan and is above the vapor producing chamber.

4. The desalination plant of claim 1 wherein the vapor producing chamber is made of copper.

5. A desalination plant for producing potable water comprising:
a housing unit;
a vapor producing chamber shaped in the form of a cylinder attached to an axle positioned centrally within the chamber that is rotatable about a central axis, the center shaft attached to the housing unit;
a fuel line shaft with a hollow interior for delivering fuel from a fuel source, the fuel line shaft mountable to the housing unit and traverses through a central area of the vapor producing chamber, the fuel line shaft includes at least one heating nozzle coupled to the shaft for heating the surface of the chamber;
a power source for driving the vapor producing chamber;
an inlet water pipe fixed at one end to a seawater source and fixed to the housing unit on the other end, the inlet water pipe providing seawater over an outer surface of the vapor producing chamber; and
a condenser unit fixed to the housing unit that receives vapor produced from the vapor producing chamber and an outlet pipe for providing condensate from the vapor.

6. The desalination plant as recited in claim 1 wherein the fuel source is natural gas.

7. The desalination plant of claim 1 wherein the condenser unit includes a suction fan and is above the vapor producing chamber.

8. The desalination plant of claim 1 wherein the vapor producing chamber is made of copper.
